(19) United States
(12) Patent Application Publication
(10) Pub. No.: US 2024/0036391 A1
(43) Pub. Date: Feb. 1, 2024

(54) LIGHT SOURCE MODULE, LIQUID CRYSTAL DISPLAY DEVICE, AND DISPLAY APPARATUS

(71) Applicant: TCL China Star Optoelectronics Technology Co., Ltd., Shenzhen, Guangdong (CN)

(72) Inventor: Bo Hai, (US)

(73) Assignee: TCL CHINA STAR OPTOELECTRONICS TECHNOLOGY CO., LTD., Shenzhen, Guangdong (CN)

(21) Appl. No.: 17/597,945

(22) PCT Filed: Jan. 14, 2022
(86) PCT No.: PCT/CN2022/071910

§ 371 Date: Jul. 13, 2023

(30) Foreign Application Priority Data
Jan. 10, 2022 (CN) 202210020566.5

(51) Int. Cl. G02F 1/13357; F21V 8/00

(52) U.S. Cl. CPC G02F 1/133603; G02F 1/133605; G02B 6/0055; G02B 6/0073

(57) ABSTRACT

A light source module, a liquid crystal display device, and a display apparatus are provided. The light source module can provide a reflective liquid crystal display panel with an area light source similar to ambient light to improve light exiting brightness of a reflective liquid crystal display panel such that the reflective liquid crystal display panel also has a better display effect in a dark environment. Furthermore, the embodiment of the present application also disposes light sources on outer sides of at least two sides of a light guide plate in the light source module, which can improve light exiting brightness of the light guide plate.

### FIELD OF INVENTION

The present application relates to a field of display technologies, especially to a light source module, a liquid crystal display device, and a display apparatus.

### BACKGROUND OF INVENTION

A liquid crystal display (LCD) device has many advantages such as thin body, power saving, no radiation, etc., is extensively applied in fields of: cell phone, personal digital assistant (PDA), digital camera, computer screen, or notebook screen.

Most of conventional liquid crystal display devices in the market are transmissive liquid crystal display devices in which a backlight source is disposed under a liquid crystal display panel, and adjusting a transmittance of the liquid crystal display panel implements display under different brightness.

### SUMMARY OF INVENTION

### Technical Issue

According to different applications, the liquid crystal display devices further include a reflective liquid crystal display device. Under irradiation of ambient light, the reflective liquid crystal display device can reflect the ambient light to perform display. Outdoor high ambient light has a better display effect. However, when brightness of ambient light is lowered, especially in a dark environment such as a night, the display effect is lowered accordingly. Especially, the reflective liquid crystal display device cannot work normally without the ambient light.

### Technical Solution

An embodiment of the present application provides a light source module, a liquid crystal display device, and a display apparatus. The light source module can provide a reflective liquid crystal display panel with an area light source such that the reflective liquid crystal display panel can achieve a better display effect both in a dark environment and under a condition without ambient light.

In a first aspect, the embodiment of the present application provides a light source module, comprising:
a light guide plate comprising a light guide surface and a light exiting surface disposed oppositely, wherein a plurality of micro structures are disposed on a light guide surface of the light guide plate at intervals;
light sources disposed on sides of the light guide plate; and
wherein the sides of the light guide plate comprise a first side and a third side disposed oppositely and a second side and a fourth side disposed oppositely, and the light sources is disposed on at least two of the first side, the second side, the third side, and the fourth side.

In some embodiments, a length of the first side is equal to a length of the third side, a length of the second side is equal to a length of the fourth side, and the length of the first side is less than the length of the second side.

In some embodiments, the light sources are disposed on an outer side of the first side and an outer side of the second side, and a reflector is disposed on an outer side of the third side and an outer side of the fourth side.

In some embodiments, the light sources are disposed on an outer side of the first side and an outer side of the third side, and a reflector is disposed on an outer side of the second side and an outer side of the fourth side.

In some embodiments, the light sources are disposed on an outer side of the second side and an outer side of the fourth side, and a reflector is disposed on an outer side of the first side and an outer side of the third side.

In some embodiments, the light sources are disposed on an outer side of the first side, an outer side of the second side and an outer side of the third side, and a reflector is disposed on an outer side of the fourth side.

In some embodiments, the light sources are disposed on an outer side of the first side, an outer side of the second side and an outer side of the fourth side, and a reflector is disposed on an outer side of the third side.

In some embodiments, the reflectors and the light guide plate are adhered together through a light transmission adhesive.

In some embodiments, the light sources are disposed on an outer side of the first side, an outer side of the second side, an outer side of the third side and an outer side of the fourth side.

In some embodiments, the micro structures are protrusion structures or recess structures.

In a second aspect, the embodiment of the present application provides a liquid crystal display device, comprising:
a reflective liquid crystal display panel; and
a light source module stacked on the reflective liquid crystal display panel layer, wherein the light source module the light source module according to claim 1, and a light exiting surface of the light guide plate is disposed toward a display side of the reflective liquid crystal display panel.

In some embodiments, the reflective liquid crystal display panel comprises a first substrate and a second substrate disposed oppositely and a liquid crystal layer disposed between the first substrate and the second substrate, a side of the first substrate away from the liquid crystal layer is disposed toward the light guide plate, and a reflective layer is disposed in the second substrate.

In a third aspect, the embodiment of the present application provides a display apparatus, comprising the liquid crystal display device as above.

Advantages

The light source module provided by the embodiment of the present application can provide the reflective liquid crystal display panel with an area light source similar to ambient light to improve light exiting brightness of the reflective liquid crystal display panel such that the reflective liquid crystal display panel can have a display effect in a dark environment and can also be used normally under a condition without ambient light. Furthermore, the embodiment of the present application also disposes the light sources on the outer sides of the at least two sides of the light guide plate in the light source module, which can improve light exiting brightness of the light guide plate to further improve light exiting brightness and display effect of the reflective liquid crystal display panel.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

To more completely understand the present application and its advantages, descriptions will be present with accompanying drawings. In the following description, the same drawing reference numbers indicate the same parts.

FIG. 1 is a schematic cross-sectional view of a light source module provided by the embodiment of the present application.

FIG. 2 is a first schematic top view of the light source module provided by the embodiment of the present application.

FIG. 3 is a second schematic top view of the light source module provided by the embodiment of the present application.

FIG. 4 is a third schematic top view of the light source module provided by the embodiment of the present application.

FIG. 5 is a fourth schematic top view of the light source module provided by the embodiment of the present application.

FIG. 6 is a fifth schematic top view of the light source module provided by the embodiment of the present application.

FIG. 7 is a sixth schematic top view of the light source module provided by the embodiment of the present application.

FIG. 8 is a schematic structural view of a liquid crystal display device provided by the embodiment of the present application.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application.

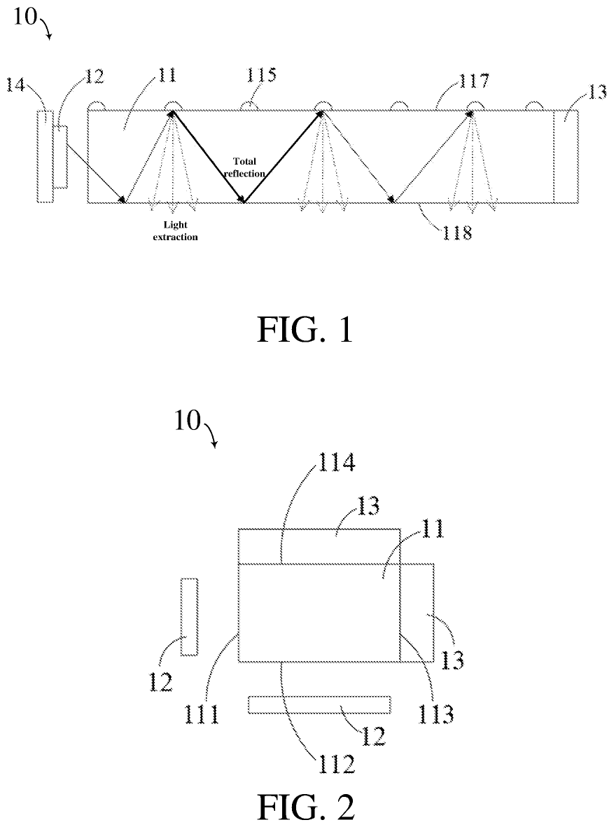

With reference to FIGS. 1 and 2, FIG. 1 is a schematic cross-sectional view of a light source module provided by the embodiment of the present application, and FIG. 2 is a first schematic top view of the light source module provided by the embodiment of the present application. The embodiment of the present application provides a light source module 10 comprising a light guide plate 11 and light sources 12 disposed on a side of the light guide plate 11. The light guide plate 11 comprises a light guide surface 117 and a light exiting surface 118 disposed oppositely. a plurality of micro structures 115 are disposed on the light guide surface 117 of the light guide plate 11 at intervals. A side of the light guide plate 11 comprises a first side 111 and a third side 113 disposed oppositely and a second side 112 and a fourth side 114 disposed oppositely. In the first side 111, the second side 112, the third side 113 and the fourth side 114, the light sources 12 are disposed on outer sides of at least two of the sides.

With reference to FIG. 2, a length of the first side 111 is equal to a length of the third side 113, a length of the second side 112 is equal to a length of the fourth side 114, and the length of the first side 111 is less than the length of the second side 112.

In some embodiments, the first side 111, the second side 112, the third side 113, and the fourth side 114 are sequentially connected in series, the first side 111 is parallel to the third side 113, the second side 112 is parallel to the fourth side 114, the first side 111 is perpendicular to the second side 112. At this time, the light guide plate 11 is rectangular. It can be understood that in some other embodiments, the light guide plate 11 can also be square or rhombic.

It should be explained that the micro structures 115 on the light guide surface 117 can perform a function of damaging light total reflection, light emitted out from the light source 12, after entering the light guide plate 11 through a light incident side, has total reflection on a region of the light guide surface 117 without the micro structures 115 such that the light is transmitted from the light incident side to a light exiting side. When light in the light guide plate 11 enters the micro structures 115, diffuse reflection occurs to result in change of light transmission direction, and a part of light is transmitted out from the light exiting surface 118 of the light guide plate 11 to achieve light extraction. In FIG. 1, a light transmission path depicted with solid lines is a total reflection path of the light, and a light transmission path depicted with broken lines is a light extraction path.

For example, the micro structures 115 can be disposed on an entire surface of the light guide surface 117 of the light guide plate 11.

The light source module provided by the embodiment of the present application 10 can provide the reflective liquid crystal display panel 20 with an area light source similar to ambient light to improve light exiting brightness of the reflective liquid crystal display panel 20 such that the reflective liquid crystal display panel 20 also has a better in display effect, a dark environment and can be used normally under a condition without ambient light 100. Furthermore, the embodiment of the present application also disposes the light sources 12 on outer sides of at least two sides of the light guide plate 11 in the light source module 10, which can improve light exiting brightness of the light guide plate 11 to further enhance light exiting brightness and display effect of the reflective liquid crystal display panel 20.

With reference to FIG. 2, In some embodiments, the light sources 12 are disposed on an outer side of the first side 111 and an outer side of the second side 112, and reflectors 13 are disposed on an outer side of the third side 113 and the outer side of the fourth side 114.

It can be understood that the reflector 13 can reflect light emitted out from the side of the light guide plate 11 back to the light guide plate 11 by a mirror surface reflection for repeated use to prevent light loss and improve light use rate such that light exiting brightness of the light guide plate 11 is increased to further improve light exiting brightness of the liquid crystal display device 100.

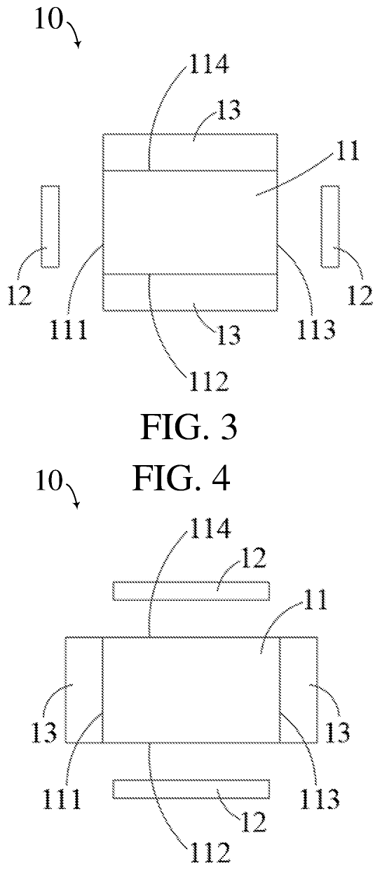

With reference to FIG. 3, FIG. 3 is a second schematic top view of the light source module provided by the embodiment of the present application. In some embodiments, the light sources 12 are disposed on the outer sides of the first side 111 and the outer side of the third side 113, the outer side of the second side 112 and the outer side of the fourth side 114.

With reference to FIG. 4, FIG. 4 is a third schematic top view of the light source module provided by the embodiment of the present application. In some embodiments, the light sources 12 are disposed on the outer side of the second side 112 and the outer side of the fourth side 114, and the reflectors 13 are disposed on the outer side of the first side 111 and the outer side of the third side 113.

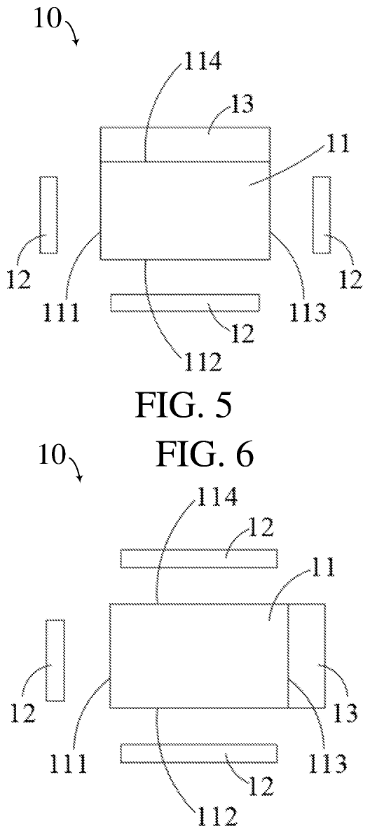

With reference to FIG. 5, FIG. 5 is a fourth schematic top view of the light source module provided by the embodiment of the present application. In some embodiments, In some embodiments, the outer side of the first side 111, the light sources 12 are disposed on the outer side of the second side 112 and the outer side of the third side 113, and the reflector 13 is disposed on the outer side of the fourth side 114.

With reference to FIG. 6, FIG. 6 is a fifth schematic top view of the light source module provided by the embodiment of the present application. In some embodiments, the light sources 12 are disposed on the outer side of the first side 111, the outer side of the second side 112, and the outer side of the fourth side 114, and the reflector 13 is disposed on the outer side of the third side 113.

It can be seen that in the embodiments of FIGS. 2 to 6, the reflectors 13 are disposed on regions of the sides of the light guide plate 11 except for a region corresponding to the light sources 12 such that a light use rate can be maximally improved.

For example, the reflectors 13 and the light guide plate 11 can be adhered together through a light transmission adhesive.

For example, a material of the reflectors 13 is metal. In some embodiments, the material of the reflector 13 can include at least one of aluminum (AI), silver (Ag), tungsten (W), copper (Cu), nickel (Ni), chromium (Cr), molybdenum (Mo), titanium (Ti), platinum (Pt), tantalum (Ta), and neodymium (Nd).

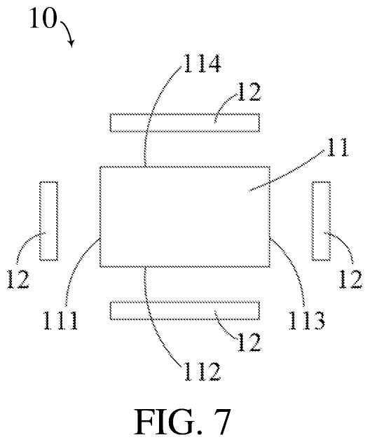

With reference to FIG. 7, FIG. 7 is a sixth schematic top view of the light source module provided by the embodiment of the present application. In some embodiments, the light sources 12 are disposed on the outer side of the first side 111, the outer side of the second side 112, the outer side of the third side 113 and the outer side of the fourth side 114. Namely, display brightness of the liquid crystal display device 100 is increased by increasing brightness of the light sources 12.

For example, a material of the light guide plate 11 can be plastic.

For example, the light sources 12 can be a light-emitting diode (LED) lamp. In some embodiments, the light sources 12 is composed of a plurality of LED lamps.

With reference to FIG. 1, the light source module 10 can further comprise a frame 14, and the frame 14 can perform a function of fixing the light sources 12.

For example, areas of the micro structures 115 are the same (namely, areas of orthographic projections of the micro structures 115 on the light guide plate 11).

In some embodiments, the micro structures 115 are distributed evenly on a surface of the light guide plate 11 at intervals.

In some other embodiments, a side of the light guide plate 11 disposed toward the light sources 12 is defined as a light incident side, a side of the light guide plate 11 disposed away from the light sources 12 is defined as a light exiting side. From the light incident side to the light exiting side, intervals between the micro structures 115 are kept uniform and consistent, and the areas of the micro structures 115 gradually increase or decrease.

In some other embodiments, from the light incident side to the light exiting side, the areas of micro structures 115 are kept uniform and consistent, and the intervals among the micro structures 115 gradually increase or decrease.

With reference to FIG. 1, the micro structures 115 can be protrusion structures. For example, protrusion structures can include at least one of curved protrusion and a conic protrusion. For example, the curved protrusion can be hemispherical, and the conic protrusion can be triangular pyramid-shaped, quadrangular pyramid-shaped, pentagonal pyramid-shaped, or hexagonal pyramid-shaped. In some embodiments, the protrusion structures can be formed by an inkjet printing process printing light transmission an ink material.

In some other embodiments, the micro structures 115 can be recess structures, the recess structures can include at least one of curved recesses and conic recesses. For example, the curved recesses can be hemispherical, and the conic recesses can be triangular pyramid-shaped, quadrangular pyramid-shaped, pentagonal pyramid-shaped, or hexagonal pyramid-shaped. In some embodiments. The recess structures can be formed by a laser process.

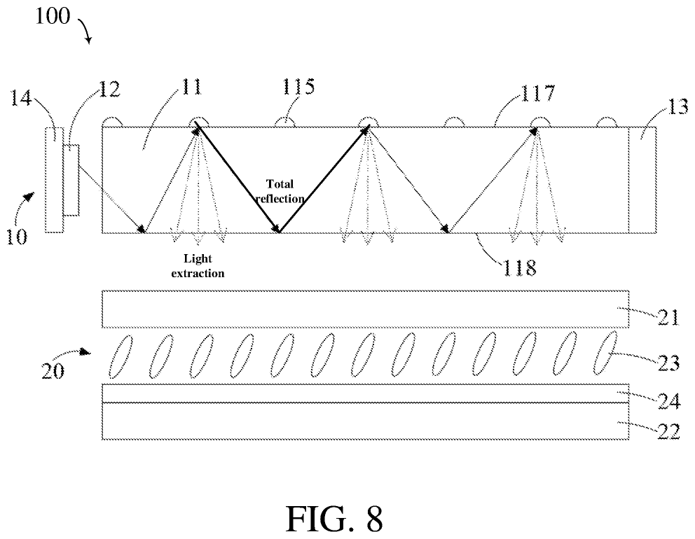

With reference to FIG. 8, FIG. 8 is a schematic structural view of a liquid crystal display device provided by the embodiment of the present application. The embodiment of the present application provides a liquid crystal display device 100 comprising a reflective liquid crystal display panel 20 and the light source module 10 stacked on each other. The light source module 10 can be the light source module 10 as any one of the above embodiments. The light exiting surface 118 of the light guide plate 11 is disposed toward a display side of the reflective liquid crystal display panel 20.

It can be understood that light extracted from the light exiting surface 118 of the light guide plate 11 would enter the reflective liquid crystal display panel 20 and provide the reflective liquid crystal display panel 20 with an area light source to enhance display brightness and display effect of the reflective liquid crystal display panel 20. Namely, the liquid crystal display device 100 provided by the embodiment of the present application, by disposing the light source module 10 stacked on the reflective liquid crystal display panel 20, can provide the reflective liquid crystal display panel 20 with an area light source similar to ambient light to improve light exiting brightness e of the reflective liquid crystal display panel 20 such that the liquid crystal display device 100 also has a better display effect in a dark environment and under a condition without ambient light. Furthermore, the embodiment of the present application also disposes the light sources 12 on the outer sides of the at least two sides of the light guide plate 11 in the light source module 10, which can improve light exiting brightness of the light guide plate 11 to further enhance light exiting brightness and display effect of the liquid crystal display device 100.

With reference to FIG. 1, the reflective liquid crystal display panel 20 includes a first substrate 21 and a second substrate 22 disposed oppositely and a liquid crystal layer 23 disposed between the first substrate 21 and the second substrate 22. A side of the first substrate 21 away from the liquid crystal layer 23 is disposed toward the light guide plate 11. A reflective layer 24 is disposed in the second substrate 22. For example, the first substrate 21 can be a color filter (CF) substrate, and the second substrate 22 can be a thin film transistor (TFT) array substrate.

It can be understood that light emitted out from the light guide plate 11, entering the reflective liquid crystal display panel 20 from a side of the first substrate 21 away from the liquid crystal layer 23, would pass through the liquid crystal layer 23 and enter the reflective layer 24. At this time, the reflective layer 24 would reflect incident light. Because the reflected light needs to pass through the liquid crystal layer 23 before emitting out from the reflective liquid crystal display panel 20. Therefore, light transmission rates of different regions of the liquid crystal layer 23 can be adjusted by controlling rotation angles of liquid crystal materials in different regions of the liquid crystal layer 23, to further control light exiting brightness of different regions of the reflective liquid crystal display panel 20.

For example, a material of the reflective layer 24 can be metal. In some embodiments, a material of the reflective layer 24 can include at least one of aluminum (AI), silver (Ag), tungsten (W), copper (Cu), nickel (Ni), chromium (Cr), molybdenum (Mo), titanium (Ti), platinum (Pt), tantalum (Ta), and neodymium (Nd).

In some embodiments, the reflective layer 24 and TFT devices in the second substrate 22 can be formed in the same process. Namely, the material of the reflective layer 24 can be the same as a material of some metal layer (for example, source electrode, drain electrode, and gate electrode) of the TFT device.

The embodiment of the present application further provides a display apparatus, including the liquid crystal display device 100 of any one of the above embodiments.

For example, display apparatus can be an electronic product such as television, advertisement screen, cell phone, tablet, computer display, game apparatus, augmented reality (AR) apparatus, (Virtual Reality, VR) apparatus, or wearable apparatus. The wearable apparatus can be smart bracelet, smart glasses, smart watch, or smart decoration.

The light source module, liquid crystal display device, and display apparatus provided by the embodiment of the present application are described in detail as above. In the specification, the specific examples are used to explain the principle and embodiment of the present application. The above description of the embodiments is only used to help understand the method of the present application and its spiritual idea. Meanwhile, for those skilled in the art, according to the present the idea of invention, changes will be made in specific embodiment and application. In summary, the contents of this specification should not be construed as limiting the present application.

What is claimed is:

1. A light source module, comprising:
a light guide plate comprising a light guide surface and a light exiting surface disposed oppositely, wherein a plurality of micro structures are disposed on a light guide surface of the light guide plate at intervals;
light sources disposed on sides of the light guide plate; and
wherein the sides of the light guide plate comprise a first side and a third side disposed oppositely and a second side and a fourth side disposed oppositely, and the light sources is disposed on at least two of the first side, the second side, the third side, and the fourth side.

2. The light source module according to claim 1, wherein a length of the first side is equal to a length of the third side, a length of the second side is equal to a length of the fourth side, and the length of the first side is less than the length of the second side.

3. The light source module according to claim 2, wherein the light sources are disposed on an outer side of the first side and an outer side of the second side, and a reflector is disposed on an outer side of the third side and an outer side of the fourth side.

4. The light source module according to claim 2, wherein the light sources are disposed on an outer side of the first side and an outer side of the third side, and a reflector is disposed on an outer side of the second side and an outer side of the fourth side.

5. The light source module according to claim 2, wherein the light sources are disposed on an outer side of the second side and an outer side of the fourth side, and a reflector is disposed on an outer side of the first side and an outer side of the third side.

6. The light source module according to claim 2, wherein the light sources are disposed on an outer side of the first side, an outer side of the second side and an outer side of the third side, and a reflector is disposed on an outer side of the fourth side.

7. The light source module according to claim 2, wherein the light sources are disposed on an outer side of the first side, an outer side of the second side and an outer side of the fourth side, and a reflector is disposed on an outer side of the third side.

8. The light source module according to claim 3, wherein the reflectors and the light guide plate are adhered together through a light transmission adhesive.

9. The light source module according to claim 1, wherein the light sources are disposed on an outer side of the first side, an outer side of the second side, an outer side of the third side and an outer side of the fourth side.

10. The light source module according to claim 1, wherein the micro structures are protrusion structures or recess structures.

11. A liquid crystal display device, comprising:
a reflective liquid crystal display panel; and
a light source module stacked on the reflective liquid crystal display panel layer, wherein the light source module the light source module according to claim 1, and a light exiting surface of the light guide plate is disposed toward a display side of the reflective liquid crystal display panel.

12. The liquid crystal display device according to claim 11, wherein a length of the first side is equal to a length of the third side, a length of the second side is equal to a length of the fourth side, and the length of the first side is less than the length of the second side.

13. The liquid crystal display device according to claim 12, wherein the light sources are disposed on an outer side of the first side and an outer side of the second side, and a reflector is disposed on an outer side of the third side and an outer side of the fourth side.

14. The liquid crystal display device according to claim 12, wherein the light sources are disposed on an outer side of the first side and an outer side of the third side, and a reflector is disposed on an outer side of the second side and an outer side of the fourth side.

15. The liquid crystal display device according to claim 12, wherein the light sources are disposed on an outer side of the second side and an outer side of the fourth side, and a reflector is disposed on an outer side of the first side and an outer side of the third side.

16. The liquid crystal display device according to claim 12, wherein the light sources are disposed on an outer side of the first side, an outer side of the second side and an outer side of the third side, and a reflector is disposed on an outer side of the fourth side.

17. The liquid crystal display device according to claim 12, wherein the light sources are disposed on an outer side of the first side, an outer side of the second side and an outer side of the fourth side, and a reflector is disposed on an outer side of the third side.

18. The liquid crystal display device according to claim 11, wherein the light sources are disposed on an outer side of the first side, an outer side of the second side, an outer side of the third side and an outer side of the fourth side.

19. The liquid crystal display device according to claim 11, wherein the reflective liquid crystal display panel comprises a first substrate and a second substrate disposed oppositely and a liquid crystal layer disposed between the first substrate and the second substrate, a side of the first substrate away from the liquid crystal layer is disposed toward the light guide plate, and a reflective layer is disposed in the second substrate.

20. A display apparatus, comprising the liquid crystal display device according to claim 11.
